(19) United States
(12) Patent Application Publication
(10) Pub. No.: US 2004/0079729 A1
(43) Pub. Date: Apr. 29, 2004

(54) Process for etching metal layer

(75) Inventors: Yi-Nan Chen, Taipei (TW); Wen-Bin Wu, Taoyuan (TW); Teng-Yen Huang, Taipei (TW); Chun-Cheng Liao, Taipei Hsien (TW); Yuan-Hsun Wu, Taoyuan (TW); Hung Wen Lin, Taipei (TW)

Correspondence Address: Quintero Law Office, 3rd Floor, 1617 Broadway, Santa Monica, CA, 90404, US

(73) Assignee: Nanya Technology Corporation

(21) Appl. No.: 10/375,710

(22) Filed: Feb. 27, 2003

(30) Foreign Application Priority Data
Oct. 25, 2002 (TW) 91125198

(51) Int. Cl. C23F 1/00; B44C 1/22; C03C 15/00; C03C 25/68

(52) U.S. Cl. 216/86

(57) ABSTRACT

A process for etching a metal layer. First, a semiconducting substrate having a metal layer and an anti-reflective layer thereon is provided. Next, the surface of the anti-reflective layer is treated with a weak base aqueous solution. Next, a photoresist layer is formed on the treated anti-reflective layer and then patterned. Next, the treated anti-reflective layer and metal layer are etched using the photoresist pattern as a mask. Finally, the photoresist pattern and anti-reflective layer are removed. The present invention prevents undercut and collapse of photoresist pattern, thus obtaining an accurate metal layer pattern.

### BACKGROUND OF THE INVENTION

1. Field of the Invention

The present invention relates to a process for etching a metal layer, and more particularly to a process for etching a metal layer that prevents photoresist undercut.

2. Description of the Prior Art

As the size of semiconductor devices decreases, for devices with a critical dimension (CD) less than 0.25 μm, a chemically amplified photoresist is generally used to define the pattern. A chemically amplified photoresist includes a protected polymer, a photoacid generator (PAG), and a solvent. The so-called protected polymer has an acid-decomposable protective group. When the chemically amplified photoresist is exposed to light through a mask, the PAG in the exposed portion generates acid, which decomposes the protective group in the polymer. Thus, the polymer becomes soluble in a base. The exposed photoresist portion can be removed by an alkaline developer.

FIGS. 1a to 1b are cross-sections illustrating the process flow of forming a photoresist pattern to etch a metal layer according to a conventional process. Referring to FIG. 1a, a metal layer 200 and an anti-reflective coating (ARC) 300 are successively formed on a semiconductor substrate 100. Then, a photoresist layer 400, such as a chemically amplified photoresist layer, is formed.

Subsequently, referring to FIG. 1b, the photoresist layer 400 is exposed through a mask (not shown) and then developed with an alkaline developer, forming a photoresist pattern P1. However, if the acidity at the interface between the photoresist layer 400 and the anti-reflective coating 300 is too strong, the acid will even encroach on the photoresist bottom in the non-exposed area, which causes photoresist undercut as shown in a photoresist pattern 420. Moreover, a photoresist pattern with a high aspect ratio (for example, aspect ration higher than 3.5) can even run the risk of collapse (see photoresist pattern 460). In consequence, when the photoresist pattern P1 is used as a mask to etch the underlying anti-reflective coating 300 and the metal layer 300 in the following procedures, an inaccurate metal layer pattern results.

### SUMMARY OF THE INVENTION

An object of the present invention is to solve the above-mentioned problems and provide a process for etching a metal layer that prevents the undercut and collapse of photoresist pattern, in order to obtain an accurate metal layer pattern.

To achieve the above objects, the present inventive process for etching a metal layer includes the following steps. First, a semiconducting substrate having a metal layer and an anti-reflective layer thereon is provided. Next, the surface of the anti-reflective layer is treated with a weak base aqueous solution. Next, a photoresist layer is formed on the treated anti-reflective layer and then patterned. Next, the treated anti-reflective layer and metal layer are etched using the photoresist pattern as a mask. Finally, the photoresist pattern and anti-reflective layer are removed.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIGS. 1a to 1b are cross-sections illustrating the process flow of forming a photoresist pattern to etch a metal layer according to a conventional process.

FIGS. 2a to 2f are cross-sections illustrating the process flow of etching a metal layer according to a preferred embodiment of the present invention.

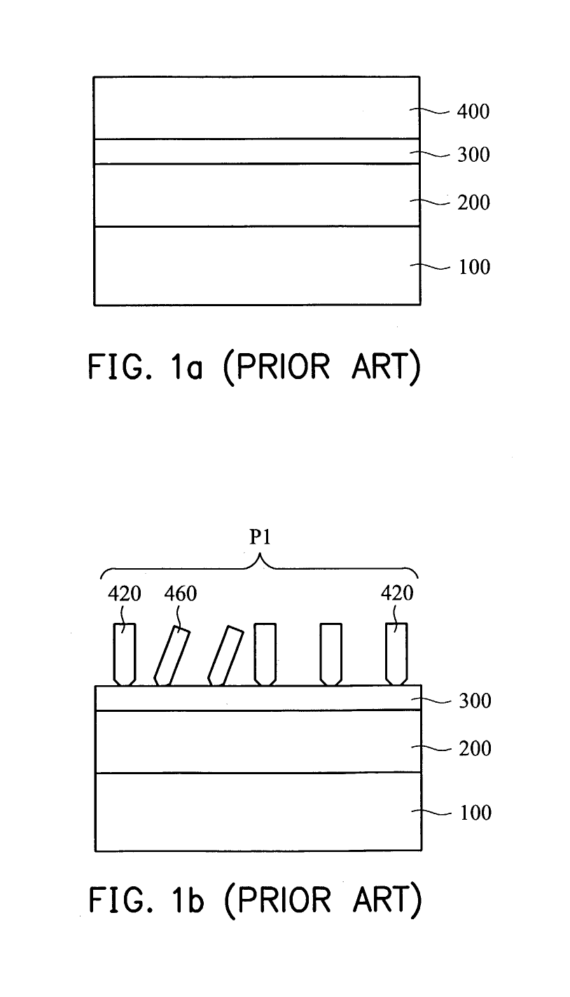

### DETAILED DESCRIPTION OF THE INVENTION

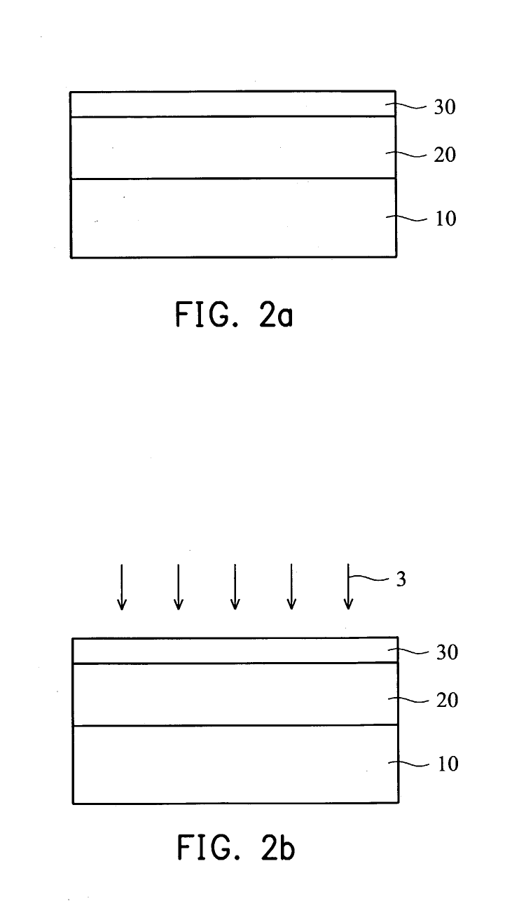

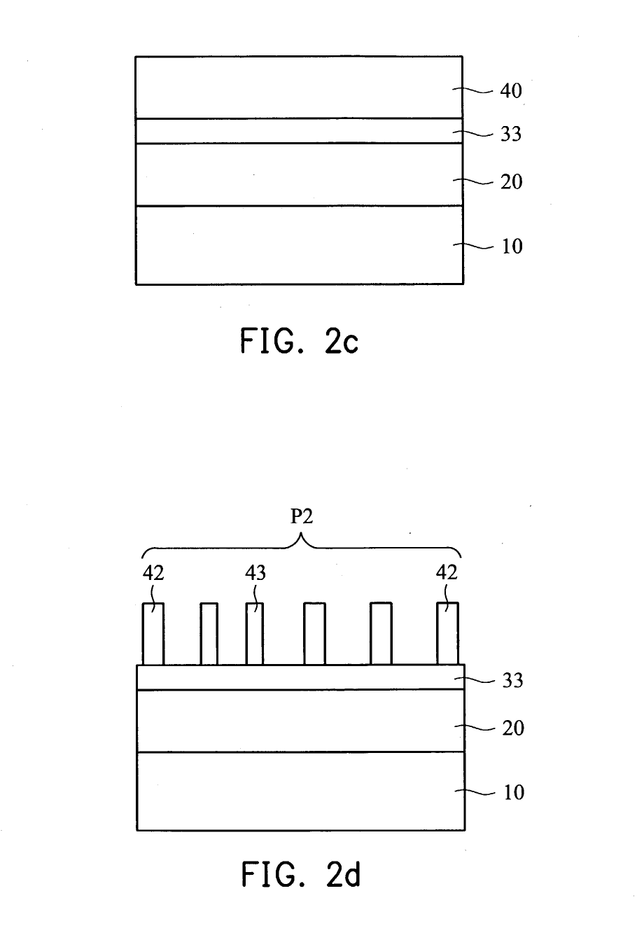

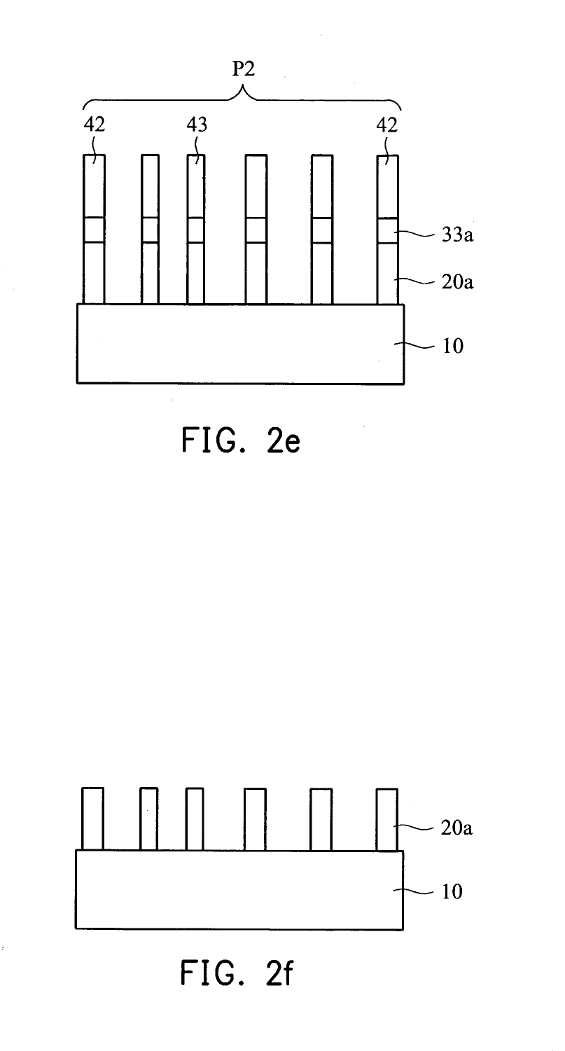

FIGS. 2a to 2f are cross-sections illustrating the process flow of etching a metal layer according to a preferred embodiment of the present invention.

Referring to FIG. 2a, a semiconducting substrate 10 is provided, on which a metal layer 20 and an anti-reflective layer (ARC) 30 are successively formed. For example, the metal layer 20 can be aluminum, an aluminum alloy, or tungsten formed by sputtering, having a thickness of 1000 Å to 20000 Å. Representative examples of aluminum alloys include AlSi, AlCu, and AlSiCu. The anti-reflective layer 30 can be Ti, TiN, or SiON (silicon oxynitride) having a thickness of 300 Å to 1400 Å. Ti and TiN can be formed by sputtering. SiON can be formed by chemical vapor deposition (CVD), for example, by plasma-enhanced CVD (PECVD) using SiH₄, N₂O, and N₂ as reactants.

Subsequently, referring to FIG. 2b, the surface of the anti-reflective layer 30 is treated with a weak base aqueous solution 3 to decrease the acidity of the anti-reflective layer 30 surface and increase the basicity. A treated anti-reflective layer 33 is thus obtained (see FIG. 2c).

The weak base aqueous solution suitable for use in the present invention can have a pH value between 9 and 11. Also, the weak base aqueous solution can include 0.05 to 0.1 wt % of a nitrogen-containing weak base, 10 to 15 wt % of an oxide, and a balance of water. The suitable nitrogen-containing weak base can be an amine, such as C₂H₅NH₂ or ammonium water (NH₄OH). The oxide suitable for use in the present invention can be a peroxide, such as hydrogen peroxide (H₂O₂).

Subsequently, referring to FIG. 2c, a photoresist layer 40, such as a chemically-amplified photoresist layer, is formed on the treated anti-reflective layer 33. Next, referring to FIG. 2d, the photoresist layer 40 is exposed, for example, exposed to 248 nm light (deep UV), through a mask (not shown). Next, the photoresist layer 40 is developed with a base developer such as TMAH (tetramethylammonium hydroxide), thus obtaining a photoresist pattern P2. Since the anti-reflective layer 33 beneath the photoresist pattern P2 has been treated with weak base, the interface between the photoresist pattern P2 and the anti-reflective layer 33 has increased alkalinity. Thus, the acid is prevented from encroaching on the photoresist bottom in the non-exposed area, which in turn avoids photoresist undercut. As shown in FIG. 2d, neither the photoresist pattern 42 having smaller aspect ratio, nor the photoresist pattern 43 having larger aspect ratio, suffers undercut or collapse.

In addition, in the above process, when the photoresist pattern is completed (see FIG. 2d), if the photoresist pattern has errors and must be reworked, O₂ plasma is first used to wash the photoresist. Then, a fresh photoresist is formed on the anti-reflective layer and patterned to form a new photoresist pattern. When the present invention uses a weak base aqueous solution that contains peroxide (such as H₂O₂) to treat the anti-reflective layer, the weak base aqueous solution also washes the erroneous photoresist and helps the rework process.

Subsequently, referring to FIG. 2e, using the photoresist pattern P2 as a mask, plasma etching is performed to remove the uncovered treated anti-reflective layer 33 and the metal layer 20. Since the photoresist pattern P2 suffers no undercut or collapse, the patterned anti-reflective layer 33a and patterned metal layer 20a obtained have accurate patterns.

The recipe for plasma etching is not limited and can be any conventional recipe. For example, a mixed gas of BCl₃/Cl₂/N₂ can be used. The BCl₃ flow rate can be 15 to 60 sccm, Cl₂ flow rate 70 to 100 sccm, N₂ flow rate 15 to 25 sccm, the pressure can be 10 to 15 mTorr, and the power can be 500 to 750 watts.

Subsequently, referring to FIG. 2f, the photoresist pattern P2 and the anti-reflective layer 33a are removed to expose the metal layer 20a. For example, O₂ plasma is used to remove the photoresist pattern P2, and then chemical mechanical polishing (CMP) is performed to remove the anti-reflective layer 33a.

In conclusion, the present invention uses a weak base aqueous solution to treat the anti-reflective layer, and the photoresist layer is formed. Since the interface between the photoresist layer and the treated anti-reflective layer has increased alkalinity, the acid is prevented from encroaching on the photoresist bottom in the non-exposed area, which in turn avoids undercut and collapse of the photoresist pattern, thus obtaining an accurate metal layer pattern.

The foregoing description of the preferred embodiments of this invention has been presented for purposes of illustration and description. Obvious modifications or variations are possible in light of the above teaching. The embodiments chosen and described provide an excellent illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A process for etching a metal layer, comprising the following steps:
providing a semiconducting substrate on which a metal layer and anti-reflective layer are formed successively;
treating a surface of the anti-reflective layer with a weak base aqueous solution;
forming a photoresist layer on the treated anti-reflective layer;
patterning the photoresist layer;
etching the treated anti-reflective layer and the metal layer using the photoresist pattern as a mask; and
removing the photoresist pattern and anti-reflective layer.

2. The process as claimed in claim 1, wherein the weak base aqueous solution has a pH value between 9 and 11.

3. The process as claimed in claim 1, wherein the weak base aqueous solution includes a nitrogen-containing weak base.

4. The process as claimed in claim 3, wherein the nitrogen-containing weak base is an amine.

5. The process as claimed in claim 4, wherein the nitrogen-containing weak base is C₂H₅NH₂.

6. The process as claimed in claim 3, wherein the nitrogen-containing weak base is ammonium water (NH₄OH).

7. The process as claimed in claim 3, wherein the weak base aqueous solution further includes an oxide.

8. The process as claimed in claim 7, wherein the oxide is a peroxide.

9. The process as claimed in claim 8, wherein the peroxide is hydrogen peroxide (H₂O₂).

10. The process as claimed in claim 1, wherein the weak base aqueous solution includes 0.05 to 0.1 wt % of a nitrogen-containing weak base, 10 to 15 wt % of an oxide, and a balance of water.

11. The process as claimed in claim 1, wherein the anti-reflective layer is SiON.

12. The process as claimed in claim 1, wherein the photoresist layer is a chemically-amplified photoresist layer.
